(19) United States
(12) Patent Application Publication
(10) Pub. No.: US 2007/0175477 A1
(43) Pub. Date: Aug. 2, 2007

(54) Personal protection, procedural and surgical mask

(76) Inventor: Richard W. Baggett, Salt Lake City, UT (US)

Correspondence Address: THORPE NORTH & WESTERN, LLP., 8180 SOUTH 700 EAST, SUITE 200, SANDY, UT, 84070, US

(21) Appl. No.: 11/646,185

(22) Filed: Dec. 26, 2006

Related U.S. Application Data
(60) Provisional application No. 60/753,843, filed on Dec. 23, 2005.

(51) Int. Cl. A62B 23/02; A62B 18/08; A62B 7/10

(52) U.S. Cl. 128/206.13; 128/206.24; 128/205.29

(57) ABSTRACT

A preformed seam, crease, or fold in the bottom portion of a surgical, procedural, or personal protection mask forms a chin pocket in the bottom of the mask to receive the user's chin therein. This pocket has been found to provide a better mask fit to reduce the air leakage around the mask not only around the user's chin, but around the entire face. The mask may also have a unique construction of the filter material which includes a filter layer and a moisture resistant layer. The mask also may include a soft comfortable layer for placement against the face of a user. The filter layer can provide an activated charcoal filter and/or a particulate filter which allows gas to pass therethrough but resists passage of bacteria, viruses, and particulate materials.

### RELATED APPLICATIONS

This application claims the benefit of Provisional Application Ser. No. 60/753,843, filed Dec. 23, 2005, and entitled “Personal Protection, Procedural, and Surgical Mask”.

### BACKGROUND OF THE INVENTION

1. Field

The invention is in the field of surgical, procedural, and personal protection masks worn over the nose and mouth of a user to filter the air breathed by the user.

2. State of the Art

There are a number of masks currently available for surgical, medical, and personal protection use. These masks usually tie behind a user's head or have straps which fit around a user's head or ears to hold the mask material over the user's mouth and nose so that air breathed in or out by the user passes through the mask. These masks generally include a metal strip along the central upper edge to be bent by a user to conform to the user's nose to substantially seal the mask around the user's nose. This strip also helps position the mask and hold the mask on the user's face. The bottom edge of such masks merely lie against the user's chin or under the user's chin. For maximum protection, all air breathed by a user must pass through the mask so the mask must fit the user to prevent flow of air around the mask. Air which flows around the mask is not filtered and such air defeats the purpose and benefit of using the mask. The usual mask of this type generally has a large amount of air leakage, i.e., allows a large amount of air to flow around the mask material which is not filtered by the mask material.

### SUMMARY OF THE INVENTION

The current invention provides a preformed seam, crease, or fold in the bottom portion of a surgical, procedural, or personal protection mask which forms a pocket in the bottom of the mask to receive the user's chin therein. This pocket has been found to seal around a user's chin to a much greater degree than with current masks to substantially reduce the air leakage around such mask and the user's chin and to tighten the mask around the user's face to fit the face to a much greater extent than a mask without the chin fold. This better fit reduces the air leakage around the mask not only around the user's chin, but around the entire face. The mask fits the face better and reduces air leakage.

The mask of the invention may also have a unique construction of the filter materials which includes a layer of an activated charcoal impregnated polypropolene to provide a carbon or activated charcoal filter, and a moisture resistant layer, for example of a waterproof or water resistant polypropolene material. The water resistant layer keeps water from entering the mask from the outside to thereby keep organisms from passing through the mask. It has been found that if a mask gets wet, organisms can pass through the mask. With the water proof or water resistant layer of the invention, even if the mask materials get wet from the inside, or the inside and outside, such layer provides a break in the wetness to prevent organisms from passing through the wet materials of the mask. The water proof or water resistant layer prevents the mask from getting completely wet.

### THE DRAWINGS

In the accompanying drawings, which show the best mode currently contemplated for carrying out the invention:

FIG. 1 is an inside elevation of the mask of the invention showing the inside surface or face of the mask;

FIG. 2 is a side elevation of an outer side of the outer surface or face of the mask;

FIG. 3 is a front elevation of a user with the mask of the invention placed on the user's face;

FIG. 4 is a side elevation of a user with the mask of the invention placed on the user's face;

FIG. 5 is a side elevation of a of a user with a slightly different embodiment of the mask of the invention placed on the user's face; and

FIG. 6 is a vertical section through a portion of the filter material used in an embodiment of the mask of the invention.

### DETAILED DESCRIPTION OF THE ILLUSTRATED EMBODIMENT

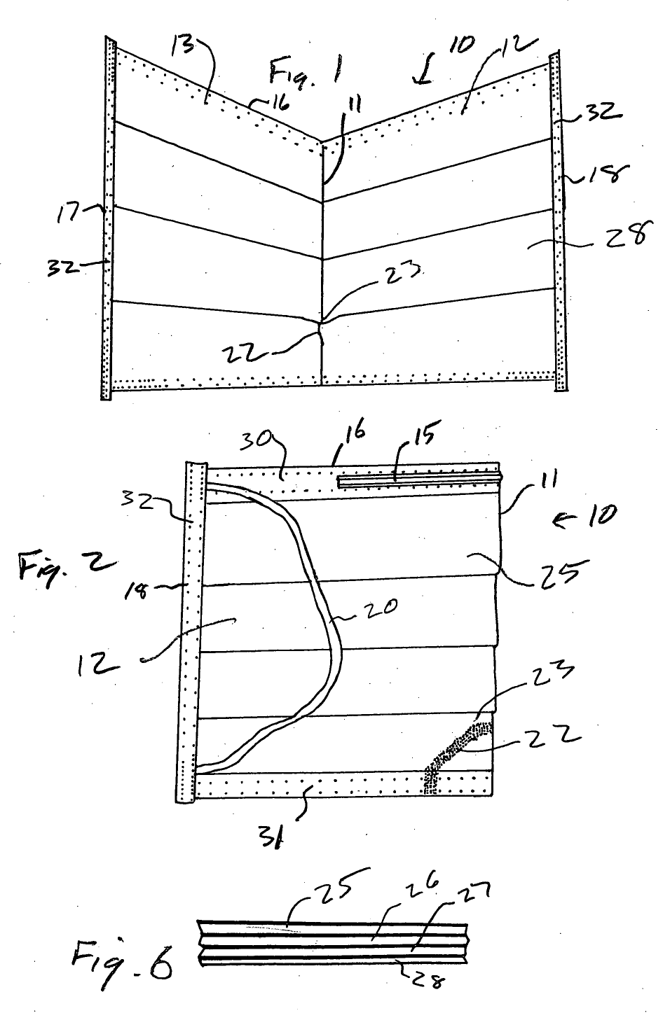

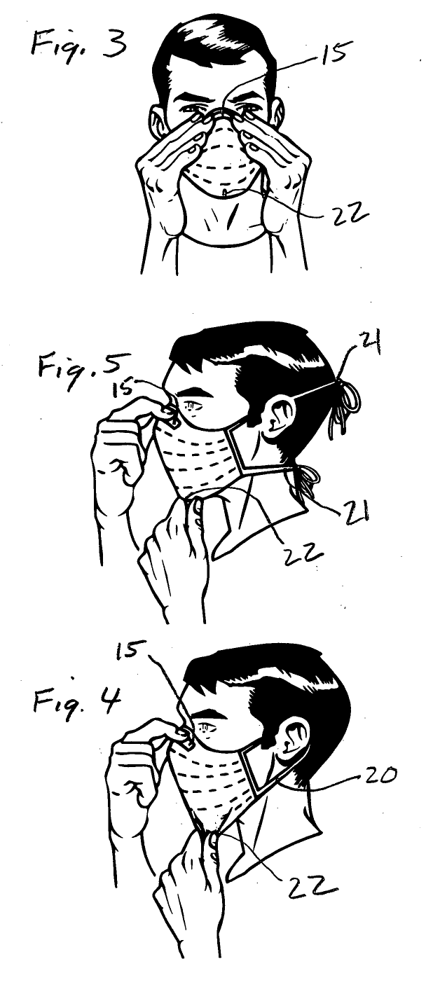

In one aspect, the current invention provides a preformed crease or fold in the bottom portion of a surgical, procedural, or personal protection mask which forms a pocket in the bottom of the mask to receive the user's chin therein. Referring to FIGS. 1 and 2, which show an example embodiment of the a mask of the invention, the mask has a fold 11 substantially centrally of the mask with mask side portions 12 and 13 on each side of the fold 11. Side portions 12 and 13 may be folded in overlying relationship. A shaping member 15 extends along the upper edge 16, such as the outside of the upper edge 16 as shown in FIG. 2, of the mask to shape the mask around the nose of the user. The shaping member 15 is positioned intermediate the opposite sides or ends 17 and 18 of the mask and is malleable so can be easily bent to shape by the user around the user's nose as shown in FIG. 3. A metal strip or wire, usually enclosed in a covering material, can conveniently be used as the shaping member. Ear loops 20, FIGS. 2 and 4, are secured to and extend from the opposite sides or ends 17 and 18 to be placed around a user's ear to hold the mask in position as shown in FIG. 4. Alternately, four ties 21, FIG. 5, two such ties extending from each side, can be used to secure the mask in place by tying corresponding ties from opposite sides together behind the user's head as shown in FIG. 5.

An important feature of the mask of the invention is the provision of a preformed seam, crease, or fold 22 in the bottom portion of the mask intermediate the opposite sides or ends 17 and 18 of the mask, and usually centered between the ends 17 and 18. The seam, crease, or fold 22 joins side portions 12 and 13 together along the seam, crease, or fold 22, and can be formed in various manners such as by thermal bonding as shown in FIGS. 1 and 2, gluing, stitching, etc. The seam, crease, or fold 22 forms a receiving pocket 23 above the crease or fold 22 in the mask to receive the chin of a user. With the chin receiving pocket 23, it has been found that the mask will seal around a user's chin to a much greater degree than with current masks to substantially reduce the air leakage around such mask and the user's chin and to tighten the mask around the user's face. The crease or fold provides a contoured mask configuration to fit a users face.

The provision of the seam 22 to form a chin receiving pocket is particularly advantageous for use with masks where the mask is formed of a substantially flat, substantially rectangular sheet of filter material folded along a substantially centered fold line 11, as shown.

The mask of the invention may also have a unique construction of the filter materials which includes a layer of an activated charcoal impregnated polypropolene to provide a carbon or activated charcoal filter, and a moisture resistant layer, for example of a waterproof or water resistant polypropolene material. The water resistant layer keeps water from entering the mask from the outside to thereby keep organisms from passing through the mask. It has been found that if a mask gets wet, organisms can pass through the mask. With the water proof or water resistant layer of the invention, even if the mask materials get wet from the inside, or the inside and outside, such layer provides a break in the wetness to prevent organisms from passing through the wet materials of the mask. The water proof or water resistant layer prevents the mask from getting completely wet.

The mask preferably has a four layer construction with an outside outer layer 25, FIGS. 6 and 2, of moisture resistant material such as waterproof or water resistant polypropolene material. A next inner layer 26, FIG. 6, is an activated charcoal impregnated material such as a polypropolene material with activated charcoal thermogenically or otherwise bonded thereto. The activated charcoal material provides an activated charcoal filter that filters out bacteria, viruses, odors, and particulate materials. A next inner layer 27 is made of a polypropolene material which allows gas to pass therethrough but resists passage of bacteria, viruses, and particulate materials. This will filter out any of these materials that make it through the activated charcoal filter. Also, this layer will prevent any charcoal particles that may separate from the charcoal filter material from passing through the mask to be inhaled by the user. A polypropolene material such as Tyvek material has been found satisfactory for this material. An inside outer layer 28, FIGS. 6 and 1, of a soft material provides a comfortable material for placement against the face of a user. This inside outer layer 28 can be made of a soft polypropolene material.

The inside outer layer material can be cut to extend beyond the upper and lower edges of the remaining materials forming the mask so that during manufacture of the mask these edges can be folded over and secured along the top and bottom edges of the outside outer layer 25 to form binding edges 30 and 31 along the top and bottom edges of the mask. The securement can be through thermogenic bonding, stitching, gluing, etc. Strips of similar material can be placed along the opposite sides of the mask to form binding edges 32 along the opposite sides. Again, the securement can be through thermogenic bonding, stitching, gluing, etc.

It has been found that the mask with the above described construction will filter out about 99.8% of organisms in the air breathed through the mask.

It should be realized that the seam, crease, or fold described can be used with masks of various constructions to provide a mask with much better fit than other masks. The mask construction with the various layers of filter materials can be used in masks without the crease or folds to provide better filtration, but without the better fit advantage.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

1. A surgical, procedural, or personal protection mask, comprising:
a piece of filter material having opposite ends and folded along a fold line intermediate the ends to form opposite overlying side portions on opposite sides of the fold line;
a seam preformed in a bottom portion of the filter material joining the opposite overlying side portions to form a chin pocket; and
means for securing the mask over the nose and mouth of a user with the user's chin received in the chin pocket.

2. A surgical, procedural, or personal protection mask, according to claim 1, wherein the piece of filter material is substantially rectangular.

3. A surgical, procedural, or personal protection mask, according to claim 2, wherein the fold line is substantially centered between the opposite ends of the filter material.

4. A surgical, procedural, or personal protection mask, according to claim 3, wherein the means for securing the mask over the nose and mouth of a user includes ear loops extending from the respective opposite ends of the mask to extend around a user's ears to hold the mask in place.

5. A surgical, procedural, or personal protection mask, according to claim 3, wherein the means for securing the mask over the nose and mouth of a user includes ties extending from the respective opposite ends of the mask to extend around a user's head to hold the mask in place.

6. A surgical, procedural, or personal protection mask, according to claim 1, wherein the seam is formed by thermal bonding.

7. A surgical, procedural, or personal protection mask, according to claim 1, wherein the piece of filter material is a layered filter material including at least one filter layer and a moisture resistant layer.

8. A surgical, procedural, or personal protection mask, according to claim 7, wherein the moisture resistant layer is a water resistant polypropolene.

9. A surgical, procedural, or personal protection mask, according to claim 8, wherein the at least one filter layer provides an activated charcoal filter.

10. A surgical, procedural, or personal protection mask, according to claim 9, wherein the at least one filter layer is a layer of an activated charcoal impregnated polypropolene.

11. A surgical, procedural, or personal protection mask, according to claim 8, wherein the at least one filter layer is of a material which allows gas to pass therethrough but resists passage of bacteria, viruses, and particulate materials.

12. A surgical, procedural, or personal protection mask, according to claim 7, wherein the mask additionally includes a layer of a soft comfortable material for placement against the face of a user.

13. A surgical, procedural, or personal protection mask, according to claim, wherein the layered filter material includes an outer layer, an inner layer adapted to be placed against the face of a user, and at least one intermediate layer between the outer and inner layers, and wherein the moisture resistant layer forms the outer layer, the soft comfortable layer forms the inner layer, and the at least one filter layer forms the at least one intermediate layer.

14. A surgical, procedural, or personal protection mask, comprising:
a piece of layered filter material including a filter layer of activated charcoal, and a moisture resistant layer; and
means for securing the piece of filter material over the nose and mouth of a user.

15. A surgical, procedural, or personal protection mask, according to claim 14, wherein the moisture resistant layer is a water resistant polypropolene.

16. A surgical, procedural, or personal protection mask, according to claim 15, wherein the at least one filter layer provides an activated charcoal filter.

17. A surgical, procedural, or personal protection mask, according to claim 16, wherein the at least one filter layer is a layer of an activated charcoal impregnated polypropolene.

18. A surgical, procedural, or personal protection mask, according to claim 14, wherein the at least one filter layer is of a material which allows gas to pass therethrough but resists passage of bacteria, viruses, and particulate materials.

19. A surgical, procedural, or personal protection mask, according to claim 14, wherein the mask additionally includes a layer of a soft comfortable material for placement against the face of a user.

20. A surgical, procedural, or personal protection mask, according to claim 14, wherein the layered filter material includes an outer layer, an inner layer adapted to be placed against the face of a user, and at least one intermediate layer between the outer and inner layers, and wherein the moisture resistant layer forms the outer layer, the soft comfortable layer forms the inner layer, and the at least one filter layer forms the at least one intermediate layer.
